(19) United States
(12) Patent Application Publication
(10) Pub. No.: US 2004/0183674 A1
(43) Pub. Date: Sep. 23, 2004

(54) Apparatus, system and method for monitoring a location of a portable device

(76) Inventor: Thomas C. Ruvarac, Aurora, IL (US)

Correspondence Address: CHARLES D. GAVRILOVICH, JR.,, A PROFESSIONAL CORPORATION, 985 PASEO LA CRESTA, SUITE A, CHULA VISTA, CA, 91910-6729, US

(21) Appl. No.: 10/768,599

(22) Filed: Jan. 30, 2004

Related U.S. Application Data
(60) Provisional application No. 60/444,084, filed on Jan. 31, 2003.

(51) Int. Cl. G08B 1/08

(52) U.S. Cl. 340/539.13

(57) ABSTRACT

A location monitoring apparatus, system and method efficiently monitors the position of a monitored device relative to the monitoring user and to a defined reference region, area, or location. The monitoring device simultaneously presents to a user the relative locations of, and directions to, a plurality of monitored devices. The monitored devices may be worn on the wrists of persons that the user wishes to monitor. The user is notified by an alarm when an alert criteria is met for one or more of the monitored devices, where the alert criteria may be based on the positional relationship of the monitored device relative to the monitoring device, the reference region or both.

### RELATED APPLICATIONS

This application claims the benefit of priority of U.S. Provisional application serial No. 60/444,084 filed on Jan. 31, 2003, entitled “Apparatus, System, And Method For Monitoring A Location Of A Portable Device” and which is incorporated by reference in its entirety herein.

### BACKGROUND OF THE INVENTION

The invention relates in general to wireless communication and more specifically to an apparatus, system and method for monitoring the location of a monitored portable device.

Monitoring and tracking devices are used to track the location of persons, objects and vehicles. An example of a typical application of such devices includes the use of a parent or care giver monitoring the location of a child. A monitored device is typically worn or otherwise attached to the person or object to be monitored while the monitoring user uses a monitoring device that provides information related to the location of the monitored device. Some systems use global positioning satellite (GPS) systems to obtain global positions of a monitored device while others rely on a relative signal strength of a signal transmitted from the monitored device. Some systems allow the monitoring user to identify the position of the monitored device relative to a global coordinate system. Other conventional systems provide an alarm if the monitored device is beyond a defined maximum distance. In certain circumstances where the monitoring device is moving, some tracking systems allow the monitoring user to determine the direction to the location of the monitored device.

Conventional systems have several limitations, however. In order to obtain information regarding the direction of the monitored device from the monitoring device, for example, conventional systems require the monitoring device to have a motion in excess of a minimum speed in a fixed direction. In chaotic and stressful situations, this limitation can be an extreme disadvantage. A parent, for example, may wish to remain stationary or may be frequently changing direction when trying to determine where a lost child is located relative to the parent's location. The need to move in a particular direction may be more than an inconvenience and may result in the parent moving away from the child. Conventional systems are further limited to allowing the monitoring user to monitor only a single monitored device with a single monitoring device. Multiple monitoring devices must be used to simultaneously monitor the location of multiple monitored devices often adding complexity and expense in certain situations. Another example of a limitation of conventional systems includes the inability to provide information regarding the location of a monitored device relative to a defined reference area.

Therefore, there is need for a location monitoring apparatus, system and method for efficiently monitoring the position of a monitored device relative to the monitoring user and to a defined reference area or location.

### BRIEF DESCRIPTION OF THE DRAWING

FIG. 1 is a block diagram of a position monitoring system in accordance with the exemplary embodiment of the invention.

FIG. 2 is a block diagram of monitoring device in accordance with the exemplary embodiment of the invention.

FIG. 3 is a schematic representation of a top view of a monitoring area in accordance with the exemplary embodiment of the invention.

FIG. 4 is a block diagram of a perspective view of a service area illustrating the criteria region in accordance with the exemplary embodiment of the invention.

FIG. 5 is a graphical representation of a visual display illustrating a relationship between a visual directional indicator and a position of the monitoring device in accordance with an exemplary orientation and relative position of the monitoring device and the monitored device.

FIG. 6 is a block diagram of a monitored device in accordance with the exemplary embodiment of the invention.

FIG. 7 is a flow chart of an exemplary method of defining a criteria region.

FIG. 8 is a flow chart of a method of monitoring the position of a monitored device in accordance with the exemplary embodiment of the invention.

FIG. 9 is a flow chart of an exemplary method of determining whether an alert criteria has been met.

FIG. 10 is a block diagram of perspective view of a monitoring device where the monitoring device is implemented as a wearable wrist unit.

### DETAILED DESCRIPTION OF THE PREFERRED EMBODIMENTS

As described above, conventional tracking and location monitoring systems are limited in several ways. Conventional systems do not allow a monitoring user to define a perimeter or area to establish alert criteria. Further, conventional systems do not allow the monitoring user to determine the direction of a monitored device relative to the monitoring device when the monitoring device is stationary or moving at a speed less than approximately two miles per hour. Since conventional systems typically determine the direction to the location of the monitored device by observing the relative motion of the monitoring device to the monitored device, the monitoring device must be moving in order to determine the direction to the monitored device. In order to indicate the direction to the position of the monitored device, the direction of motion of the monitoring device must be determined to provide a reference direction. The direction to the monitored device can then be displayed relative to the motion of the monitoring device. In situations where the monitoring user is stationary, frequently changing motion or moving slowly, the reference direction can not be determined and the monitoring user is not provided with the direction to the location of the monitored device. Where, the monitoring user is a parent and the monitored device is attached to a child, this shortcoming of conventional systems can be an extreme disadvantage. The parent is likely to be distraught, frantic, and frequently changing direction in searching for the child. Further, the parent may be stationary when the need to find the child arises.

These and other limitations are overcome in the exemplary embodiment of the invention. A monitoring device provides a monitoring user with location information regarding any number of monitored devices. The monitoring user can receive a tracking direction to track the location of a monitored device relative to the monitoring device while either or both of the devices are stationary or while frequently changing direction. In the exemplary embodiment, the monitoring device takes into account the orientation of the monitoring device relative to the location of the monitored device when providing a direction indicator indicating the direction to the monitored device. Further, the monitoring device provides an alert indication when an alert criteria is met, where the alert criteria may be based on the relative distance between devices or the position of the monitored device relative to a defined area.

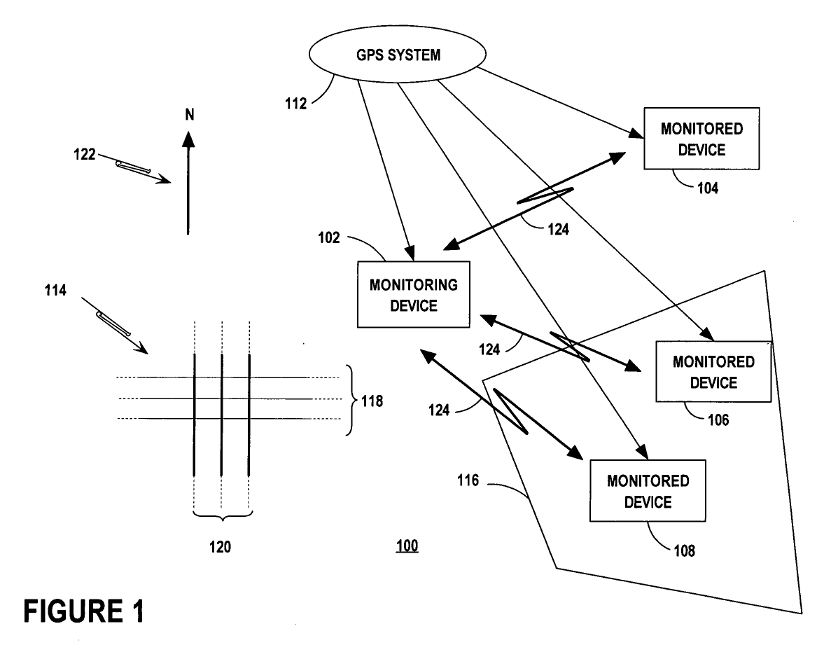

FIG. 1 is a block diagram of a location monitoring system 100 in accordance with the exemplary embodiment of the invention. In the exemplary embodiment, a monitoring device 102 is used by a user (not shown) to monitor the location of one or more monitored device 104-108. The monitored devices 104-108 are portable and are worn or otherwise attached to children, pets, vehicles, toys, prison detainees, the elderly, special needs persons or any other object or persons that the user wishes to monitor or track. As described in detail below, the exemplary monitoring system 100 can be configured to manage 1,2,3, or 4 monitored devices 104-108. The monitoring system 100, however, may include any number of monitoring devices 102 and monitored devices 104-108. For example, in an alternate embodiment of the invention, the monitoring device 102 is implemented as a portable unit with sufficient display, memory and processing power to simultaneously monitor ten devices 104. In FIG. 1, a single monitoring device 102 and three monitored devices 104, 106, 108 are illustrated as an example. In addition to other features of the exemplary monitoring system 100, the monitoring user is alerted when defined alert conditions and criteria regarding the location of the monitored device 104 are met.

A global positioning satellite (GPS) system 112 provides signals and information to each of the monitoring devices 102 and monitored devices 104-108 allowing each of the devices 102, 104-108 to determine their corresponding global position relative to a global positioning coordinate system 114. An example of a suitable global positioning coordinate system 114 is the longitude and latitude coordinate system used to define locations on the globe. As is known, such a system includes a grid formed by defined lines encircling the globe through the poles (longitude) 120 and series of lateral lines parallel to the equator (latitude) 118. Any location on the Earth can be described using latitude and longitude in degrees, minutes, seconds and fractions of seconds. Each tracked device 104-108 wirelessly transmits its global position to the monitoring device 102 through a wireless communication channel 124. The monitoring device 102 uses the monitored device global positions to determine if any alert criteria has been met. If an alert criteria is met, an alert indication is provided to the monitoring user.

As discussed below, the alert criteria can be based on any number of factors and conditions. In the exemplary embodiment, the alert criteria is based on a relative distance between the monitored device 104 and the monitoring device 102, a global position of a monitored device 106 relative to a defined region 116, or both. The alert criteria may be defined to indicate an alert situation if the monitored device 104 is outside of the defined criteria region 116 or when the monitored device 106 is inside the defined region 116. The latter may be useful, for example, where a parent monitoring the location of a child, defines a closed perimeter around a body of water such a pond. When the child enters the defined perimeter, an alert condition is met and an alert indication is presented to the parent notifying the parent that the child is near the body of water.

In the exemplary embodiment, the monitoring device 102 provides a tracking direction through a direction indicator. An example of a suitable direction indicator is an arrow displayed on a visual display of the monitoring device 102 where the arrow indicates the direction to the monitored device 104. As discussed below in further detail, the monitoring device 102 utilizes a global reference direction 122 to determine the orientation of the monitoring device 102 relative to the location of the monitored device 104. The direction indicator is displayed taking into account the orientation of the monitoring device 102 such that as the monitoring device 102 is rotated, the direction indicator remains pointing in the direction of the monitored device 104. In the exemplary embodiment, the monitoring device 102 determines a global reference direction 122 from a compass providing the direction of magnetic north. An offset angle is determined based on the orientation of the monitoring device 102 relative to magnetic north. The offset angle is applied to the tracking direction from the monitoring device 102 to the monitored device 104 to provide the tracking direction indicator on the display of the monitoring device 102, allowing the user to view the direction toward the monitored device 104.

In the exemplary embodiment, a direction indicator for each monitored device 104-108 is simultaneously presented to the user. As discussed below, a direction indicator such as an arrow for each monitored device 104-108 is displayed on the visual display of the monitoring device 102. This allows the user know the relative location of every monitored device 104-108 by a single glance at the display.

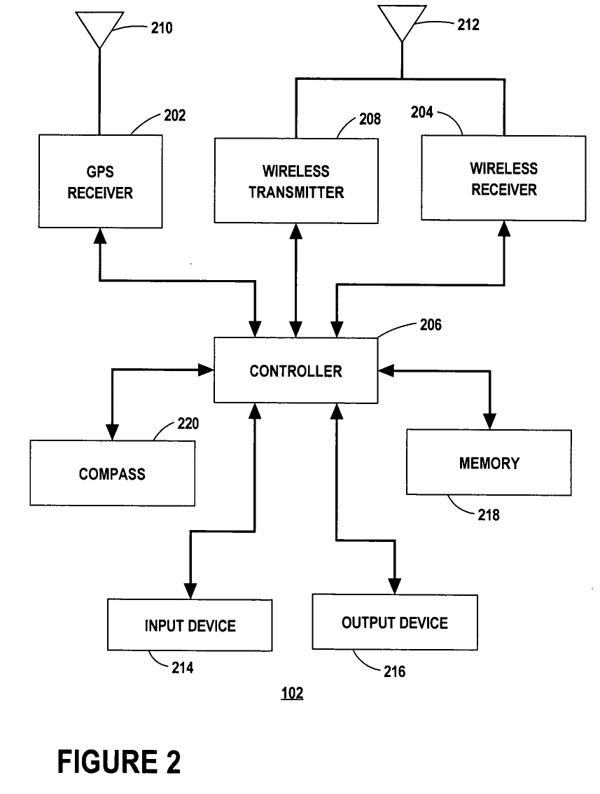

FIG. 2 is block diagram of a monitoring device 102 in accordance with the exemplary embodiment of the invention. The monitoring device 102 may have any of one of several form factors and may be wholly or partially embodied in other devices such as, for example, cellular telephones, personal digital assistants (PDAs), and computers. In the exemplary embodiment, the monitoring device 102 is implemented as a wearable wristwatch that can be attached to the user's wrist. The monitoring device 102 includes at least a GPS receiver 202, a wireless receiver 204, a compass 220, and a controller 206. In the exemplary embodiment, the monitoring device 102 also includes a wireless transmitter 208, a memory device 218, an input device 214, and an output device 216. The various functional blocks illustrated in FIG. 2 may be implemented in any number of analog or digital circuits, integrated circuits (ICs), Application Specific Integrated Circuits (ASICs), processors or other devices. Further, the functional blocks, or portions of the functional blocks may be implemented in other devices. For example, a keyboard of a laptop computer may be used as the input device 214 or a display on a PDA may be used as the output device 216.

The GPS receiver 202 is any one of several commercially available devices capable of receiving GPS signals and providing a global position of the monitoring device 102. In the exemplary embodiment, the GPS receiver 202 is the GRF2i/LP SiRFstar integrated circuit that is part of the SiRFstarlle/LP chip set available from the Sirf company. The GPS receiver 202 receives GPS signals through a GPS antenna 210 from a GPS system 112 in accordance with known techniques and provides a monitoring device global position of the monitoring device 102. Although other formats may be used to represent the global position, the monitoring device global position is represented as a longitude and latitude pair expressed as degrees, minutes and seconds.

The wireless receiver 204 includes circuitry that receives wireless signals through an antenna 212 from one or more monitored devices 104-108. The wireless receiver 204 demodulates the signals and forwards the received information to the controller 206. The received information at least includes the monitored device global position of at least one monitored device 104. The received information, however, may include other information such as messages from the monitored device, medical statistics of the person wearing the monitored device 104 such as heart rate or temperature, or other information such as, for example, the ambient temperature at the monitored device 104. Further, in some circumstances, the received signals may include programming signals or criteria data from a programming device or system. Programming information may include, for example, predefined criteria regions for a particular theme park or public area.

The controller 206 is a processor, microprocessor, computer, controller, micro-controller, ASIC, or any other type of circuit or processor arrangement capable of executing software code in accordance with the functions described herein as well as facilitating the overall operation of the monitoring device 102. An example of a suitable controller is the GSP2e/LP microprocessor integrated circuit which is part of the SiRFstarlle/LP chip set available from the Sirf company.

A memory device 218 provides electronic storage of data, software code or other information that can be accessed by the controller 206. An example of a suitable memory device 218 is an integrated circuit memory device. Those skilled in the art will readily recognize that the memory 218 may be implemented using a variety of techniques and devices. The memory 218, for example, may be implemented as part of the controller 206 in some circumstances.

A compass 220 provides a global reference direction to the controller 206. The global reference direction maybe any reference direction that can be used to determine the orientation of the monitoring device 102 relative to the Earth. In the exemplary embodiment, the global reference direction is due North and the compass 220 is an electronic compass of an Ml chipset available from the Aichi company of Japan. An example of another type of suitable compass 220 is a gyroscopic compass.

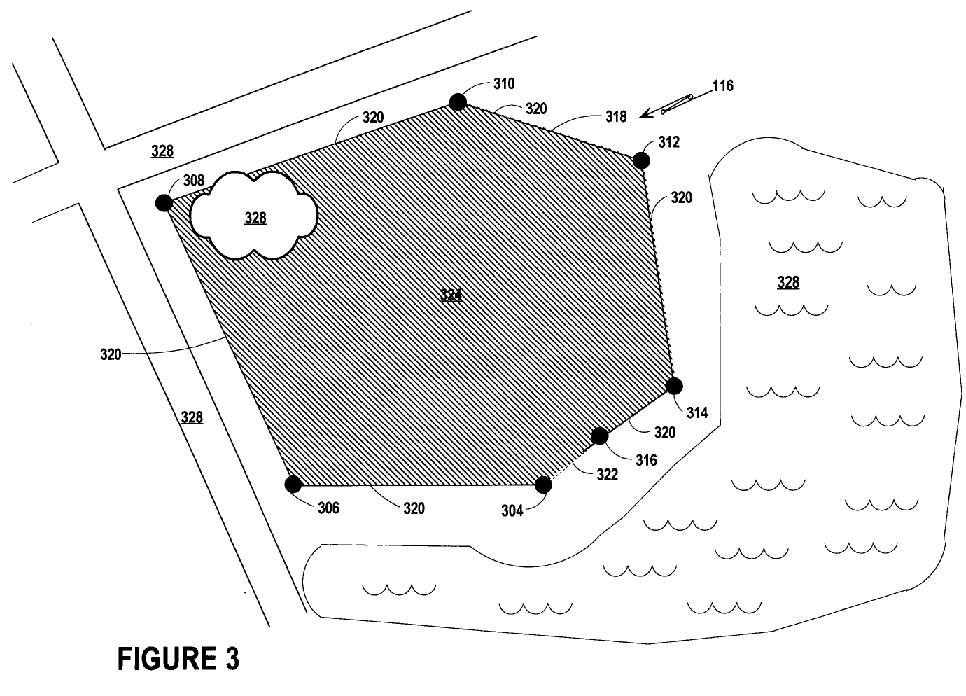

The output device 216 provides a user interface to the monitoring user and may provide audible, visual, vibratory or multimedia information to the monitoring user. In the exemplary embodiment, the output device 216 includes a speaker and a visual display. An example of a suitable visual display (216) is a liquid crystal display (LCD) with backlighting. As described with reference to FIG. 3 below, the monitoring device 102 has a form factor similar to a wristwatch and includes a band that allows the device 102 to be worn on the wrist of the monitoring user. The visual display (216), therefore, is chosen to have a size that allows for easy viewing at a distance typically used to view a watch while also fitting in the wristwatch form factor.

The input device 214 provides a user interface for entering data, commands or other information. The input device 214 may be a keyboard, array of push buttons, a touch screen or microphone. In the exemplary embodiment, the input device 214 includes an array of buttons switches that allow the monitoring user to scroll through lists, navigate through menus and enter information.

In the exemplary embodiment, the monitoring device 102 may be in one of three operational modes: setup/data entry mode; criteria region setup mode; position monitoring/tracking mode. During the setup/data entry mode, the monitoring device 102 is configured in accordance with the monitoring users preferences. A maximum distance threshold is entered and stored in memory 218. The maximum distance threshold sets the maximum relative distance between the monitoring device 102 and each of the monitored devices 104-108. In some circumstances, a unique maximum threshold can be associated with each of the monitored devices (104-108). The maximum distance threshold for one monitored device 104 may be set to 50 feet for a young child, for example. A second maximum distance threshold can be set to 300 feet for another monitored device 106 that may be worn by an older child. Other information that can be entered includes icon shapes, colors, or audible tone preferences for uniquely identifying each of the monitored devices 104-108. Those skilled in the art will recognize the other information and data can be entered to configure the monitoring device 102 that depends on the particular features and alert criteria supported by a particular embodiment. For example, a maximum speed threshold can be entered for one or more of the monitored devices 104-108 during the setup mode if the particular monitoring system 100 supports an alert criteria related to the maximum speed of a monitored device 104-108.

In the exemplary embodiment, it may be necessary to calibrate the monitoring device 102. For example, as often performed in other devices utilizing a magnetic compass, it may be necessary to calibrate the monitoring device 102 to compensate for the difference between magnetic north and polar north based on the geographical location of the monitoring device 102. In accordance with known techniques, the monitoring device 102 accepts data entered by the user indicating the geographical region where the monitoring device 102 will be used. A compensation value stored in memory 218 is applied to compensate for the difference between the magnetic north and the polar north, allowing the monitoring the device to accurately determine the positions of the monitored devices 104-108 based on the GPS data and the polar north reference.

FIG. 3 is a top view schematic representation of a service area 300 in accordance with an example of a defined criteria region 116. The defined criteria region 116 is defined during the criteria region setup mode. In FIG. 3, the criteria region appears as a two dimensional area 324. As explained below, the criteria region 116 is a criteria area 324 if no altitude is used to define the criteria region 116.

In the exemplary embodiment, the criteria region 116 can be defined using one of at least two procedures including a physical outline procedure and a graphic interface procedure. Using the physical outline procedure, a criteria perimeter 318 around the criteria area 324 is entered by physically moving along a desired perimeter 318 and selecting a series of definition points 304-316 to define a series of line segments 320,322 that form a polygon. An altitude criteria defines the criteria region 116 as a three dimensional volume. In the exemplary embodiment, the definition points 304-316 are selected by activating a button or switch on the monitoring device 102 when the monitoring device 102 is positioned in the desired location of a definition point (304-316). Therefore, the individual entering the data begins the procedure by moving to a location 304 that is along the perimeter 318 of the defined criteria region 116 and pushing a selection button while positioned in that location 304. The individual continues by moving to another location 306 along the perimeter 318 and again activating the selection button. Each time the selection button is depressed, the controller 206 stores the current monitoring device global position into memory 218. When the individual has reached the last point 316 of the perimeter 318, the individual indicates to the monitoring device 102 that the perimeter 318 has been defined by activating an ‘area completed’ indicator. A suitable activation technique includes depressing another button that indicates the last definition point 316 has been reached. In response, the controller 206 renders a closed polygon (318) by connecting the points in the order they were selected and connecting the last point 316 to the first point selected 304 if the first point 304 and last point 316 are not collocated. The line segment 322 between the last and first definition points 316, 304 is drawn as a dashed line in FIG. 3 to illustrate that, in some situations, the last line segment 322 is approximated by the process running on the monitoring device 102. Any number of known techniques may be used to select the definition points 304-316. An examples of another suitable technique for entering the definition points 304-316 along the perimeter 318 includes using voice recognition or voice detection techniques and vocally indicating that a definition point (304-316) should be stored when the monitoring device 102 is located at a definition point (304-316).

For exemplary purposes, the service area 300 illustrated in FIG. 3 shows hazard areas 328 including a pond and streets. Any area may be considered as a hazard area 328 for the user. For example, play ground equipment including “monkey bars” may be considered a hazard area 326. A hazard area 326, is based on a definition by the user and is not necessarily considered a hazard area by all users. The criteria perimeter 318 may be defined adjacent to or around a hazard area 326.

In addition to providing a defined criteria perimeter 318, the user may establish an altitude criteria and may define the criteria area 324 as an interior criteria or an exterior criteria. When the criteria area 324 is defined as an exterior criteria area, the areas outside of the defined criteria area 324 are considered a hazard. An interior criteria area defines the interior of the perimeter 318 as the hazard. Defining an interior criteria region may be useful where a perimeter 318 is defined around the hazard area 326 such as a pond or a swimming pool. In such a situation, the monitoring device 102 is configured to provide an alarm when the monitored device 104 is inside the criteria region 116.

The graphic interface procedure for selecting the defined criteria region 116 includes observing a generated visual image of a map of the area and entering data using the input device (216). Using the input device 214, a cursor displayed on the visual display (216) is moved to the desired location on the map and selected by, for example, depressing a button or “double clicking” at the location using a computer mouse. The data required to generate the map may be stored in memory 218, downloaded from other devices, or received through a communication network. The compass provides the global reference direction, such as due North, to the controller 206. The controller 206 superimposes the map to coincide with a global coordinate system referenced to the orientation and location of the user.

Another example of a technique of defining the defined criteria region 116 includes viewing a display that provides a grid or other visual coordinate system representing the distances from the user location and selecting the definition points 304-316 using the input device 214. In yet another example, the user may view the display on the monitoring device 102 and enter data to select a defined criteria region 116 of the desired shape and size relative to the users location and orientation. The user may select a square, for instance, representing a defined criteria region 116 having sides 30 feet in length and having a center coinciding with the user's current location. Based on the these teachings and known techniques, those skilled in the art will recognize the various other methods for defining the defined criteria region 116.

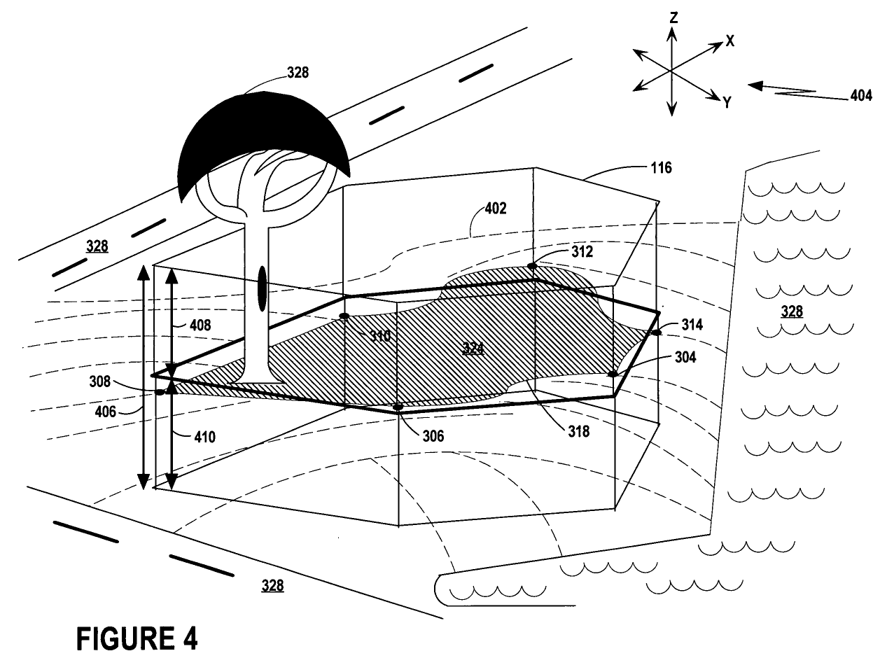

FIG. 4 is a perspective view of the service area 300 illustrating the criteria region 116 as a three dimensional volume in accordance with the exemplary embodiment of the invention. In FIG. 4, several dashed lines 402 depict a terrain of the service region 300 and illustrate the varying altitude of the surface of the Earth within the service region 300. As mentioned above, the global coordinate system 122 used in the exemplary embodiment is the GPS coordinate system 404 which includes an x, y and z axis. Since the definition points 304-316 are along the surface of the Earth, the criteria perimeter 318 approximates a projection of the criteria area 324 along a z axis onto the Earth. In the exemplary embodiment, the criteria area 324 is defined in the X-Y plane and the altitude criteria 406 is defined in the z direction. Although the altitude criteria 406 may have any configuration, direction or definition, in the exemplary embodiment, the altitude criteria 406 has a height above 408 and height below 410 a reference altitude of the criteria area 324. A suitable reference altitude is an average of the altitudes of each of the definition points 304-326. Another suitable altitude reference is the altitude of the first definition point 304. In some circumstances, the reference altitude may be defined by the user during the criteria region setup mode. The user may enter an altitude reference through the input device 214 or may activate a switch such as an input button when located at the desired altitude. Those skilled in the art will recognize the numerous variations and modification to define an altitude reference based on these teachings. Therefore, the criteria region 116 is a three dimensional volume having a criteria area 324 defined in a plane of the reference altitude. In FIG. 3, the criteria region 116 appears as a criteria area 324 and has a perimeter that coincides with the line segments 320, 322 of the polygon. In FIG. 4 the criteria region 116 is illustrated at a three dimensions in perspective view and the perimeter 318 follows the contours of the Earth. Since the monitored device global position is evaluated in relation to the X and Y coordinates when determining the location of the monitored device 104 relative to the criteria area 324, the outline of the criteria area 324 and the perimeter are the same shape.

During a position monitoring mode of the monitoring device 102, the controller 206 determines if any alert criteria has been met. The monitoring device 102 presents an alert indication to the user when the alert criteria is met. The alert indication may be a visual alarm such as a flashing light or visual icon on the display or it may be an audible alarm such an alert tone transmitted from the speaker (216), or a vibratory alarm, or any combination thereof. As discussed above, the user sets the alert criteria to be based on a maximum distance or on a defined criteria region 116 or both.

In each of the monitored devices 104-108, a GPS receiver receives GPS signals and determines its monitored device global position. The monitored device global position is modulated and wirelessly transmitted to the monitoring device 102 as a global position message. The wireless receiver 204 in the monitoring device 102 receives and demodulates the global position message to produce the monitored device global position. The controller 206 receives the monitoring device global position from the GPS receiver 202 and applies the alert criteria. In the exemplary embodiment, the software code running on the controller 206 facilitates the method of monitoring the monitored devices 104-108.

In determining whether a maximum distance criteria for a particular monitored device 104 had been met, the monitoring device 102 determines the distance between the monitoring device 102 and the monitored device 104 by calculating the distance between monitoring device global position and the monitored device global position. The monitored device distance is compared to the maximum distance corresponding to the particular monitored device 104 that is stored in memory 218. If the distance is less than or equal to the maximum distance, the controller determines that the alert criteria is not met. Otherwise, the controller continues by determining if a defined criteria region 116 applies to the monitored device 104. If no defined criteria region 116 is associated with the monitored device, the monitoring device 102 continues to monitor the location of the monitored devices 104-108. If a defined criteria region 116 is associated with the particular monitored device 104, the controller 206 determines if the defined alert criteria has been met. In the exemplary embodiment, the controller determines if the alter criteria has be met by comparing the monitored device global position to each line segment of the polygon associated with the defined criteria region 116. Each line segment is categorized as either vertical, horizontal, positive slope or negative slope. Each line segment has an inside plane and an outside plane and the controller determines if the monitored device global position is located within the inside plane or the outside plane by comparing the equation of the line segment to the monitored device global position. If it is found that the monitored device global position is within the inside plane of each line segment, the controller 206 determines that the monitored device is within the defined criteria region 116 the alert criteria is met if the alert criteria is defined as being met when the monitored device is inside or outside the area and whether the If the alert criteria is defined as being met when the controller determine if the alert criteria is met by applying the entered definition of defined

Based on these teachings and known techniques, those skilled in the art will recognize other methods of determining the position of the monitored device relative to the defined area. One example of a method includes storing all coordinates that are within the defined area and determining if the monitored device global position matches any of the stored values.

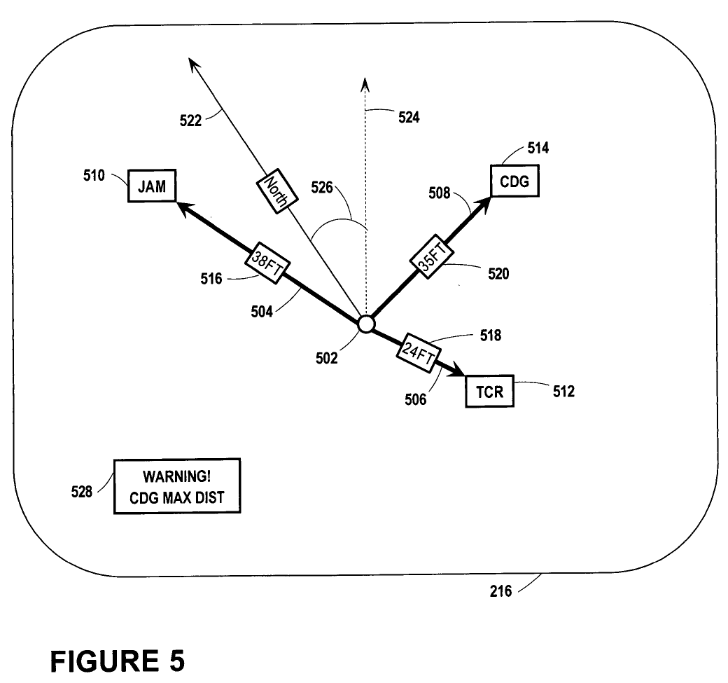

FIG. 5 is an illustration of an output device 216 in accordance with the exemplary embodiment where the output device 216 is a visual display. During the tracking mode, the user is presented the location of and direction to each monitored device 104-108. The location of the monitored device 104 is represented by a monitoring location 502 displayed as a small circle (502) on the display (216). Each of a plurality of direction indicators 504-508 are displayed as a vector and represent a distance and direction to a corresponding monitored device 104-108 from the monitoring location 502. In the exemplary embodiment, a distance indicator 516-520 is associated with each vector 504-508 to provide a numeric indication of the distance from the monitoring location 502 to the position of each monitored device 104-108. Each vector is associated with an identity indicator 510-514 that uniquely identifies each vector 504-508 as corresponding to a particular monitored device 104-108. The information may be displayed in any of several ways in addition to the technique illustrated in FIG. 5. The distance indicators 516-520 and the identity indicators 510-514 may be combined in a single indicator displayed near or within the corresponding vector 504-508. Further, one or more of the indicators may not be displayed in some circumstances.

The output device 216 includes a warning indicator in the exemplary embodiment. The warning indicator 528 may display any number of warnings or information to the user. In the exemplary embodiment, a warning indicator 528 is displayed to indicate the meeting of any alert criteria. Examples of suitable warnings include indications that one or more of the monitored devices 104-108 has exceeded a maximum distance from the monitoring device location 502, has exceeded maximum or minimum altitude, or has a positional relationship meeting an alert criterion. Other examples of warning indications may be related to a maximum or minimum ambient temperature at the monitored device 104-108 or a maximum or minimum temperature of a person wearing the monitored device 104-108. Identical alert criteria may be set for all of the monitored devices 104-108 or each monitored device 104-108 may be associated with unique alert criteria.

As mentioned above, the monitoring device 102 utilizes a global reference direction 122 to determine the orientation of the monitoring device 102 relative to the location of the monitored device 104. The direction indicator 504 is displayed taking into account the orientation of the monitoring device 102 such that as the monitoring device 102 is rotated, the direction indicator 504 remains pointing in the direction of the monitored device 104. In the exemplary embodiment, the monitoring device 102 determines a global reference direction 122 from the compass 220 providing the direction of magnetic north. The global reference direction 122 is displayed on the output device 216 as a reference indicator 522. In the exemplary embodiment, polar north is used at the global reference direction 122 and a calibration procedure is used to reference the direction of magnetic north provided by the compass 220 to determine polar north. Accordingly, the reference indicator 522 indicates the direction of polar north in the exemplary embodiment. An offset angle 526 is determined based on the orientation 524 of the monitoring device 102 relative to global reference direction and, therefore, also relative to magnetic north. The offset angle 526 is applied to the tracking direction from the monitoring device 102 to the monitored device 104 to provide the tracking direction indicator on the display of the monitoring device 102, allowing the user to view the direction toward the monitored device 104.

In the exemplary embodiment, therefore, the output device 216 is a visual display simultaneously presenting a plurality of tracking indicators 504-508 indicating the tracking direction to each location of a plurality of monitored devices 104-108. Additional information is provided to the user allowing the user to quickly identify alert situations and the locations of each monitored device 104-108.

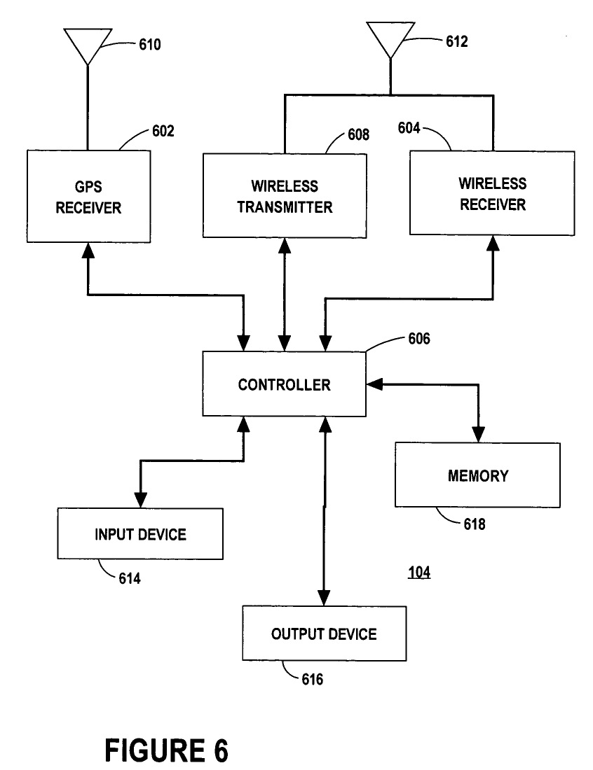

FIG. 6 is a block diagram of a monitored device 104 in accordance with the exemplary embodiment of the invention. The monitored device 104 may have any of one of several form factors and may be wholly or partially embodied in other devices such as, for example, cellular telephones, personal digital assistants (PDAs), and computers. In the exemplary embodiment, the monitored device 104 is implemented as a wearable wristwatch that can be attached to the wrist of a person that is monitored. As discussed below, in a pet trainer exemplary embodiment, the monitored device 104 includes a collar for attaching the monitored device 104 to a pet. The monitored device 104 includes at least a GPS receiver 602, a wireless transmitter 608, and a controller 606. In the exemplary embodiment, the monitored device 104 also includes a wireless receiver 606, a memory device 618, an input device 614, and an output device 616. The various functional blocks illustrated in FIG. 6 may be implemented in any number of analog or digital circuits, integrated circuits (ICs), Application Specific Integrated Circuits (ASICs), processors or other devices. Further, the functional blocks, or portions of the functional blocks may be implemented in other devices. For example, a keyboard of a laptop computer may be used as the input device 614.

The GPS receiver 602 is any one of several commercially available devices capable of receiving GPS signals and providing a global position of the monitoring device. In the exemplary embodiment, the GPS receiver GRF2i/LP SiRFstar integrated circuit that is part of the SiRFstarlle/LP chip set available from the Sirf Company. The GPS receiver 202 receives GPS signals through a GPS antenna 610 from a GPS system in accordance with known techniques and provides a monitoring device global position of the monitored device 104. Although other formats may be used to represent the global position, the monitoring device global position is represented as a longitude and latitude pair expressed as degrees, minutes and seconds.

The controller 606 is a processor, microprocessor, computer, controller, micro-controller, ASIC, or any other type of circuit or processor arrangement capable of executing software code in accordance with the functions described herein as well as facilitating the overall operation of the monitored device 104. An example of a suitable controller is the SiRFstar microprocessor available from the Sirf Company. After receiving the monitored device global position from the GPS receiver 602, the controller 606 performs any required processing and forwards the monitored device global position to the wireless transmitter 608. The controller 606 processes and forwards information received from an input device 614 as well as forwarding signals to the output device 616 and accessing the memory 618.

The wireless transmitter 608 includes circuitry that transmits signals through the antenna 612 to the monitoring device 102. The transmitter modulates signals to be transmitted in accordance with the modulation scheme used in the system 100 and at least transmits the monitored device global position to the monitoring device 102. The transmitter 608, however, may transmit other information such as voice signals or data.

The wireless receiver 604 includes circuitry that receives wireless signals through an antenna 612 from the monitoring device 102. The wireless receiver 604 demodulates the signals and forwards the received information to the controller 606. The received information may include voice signals, or alarms, data, control signals or any other type of information sent by the monitoring device 102.

A memory device 618 provides electronic storage of data, software code or other information that can be accessed by the controller 606. Those skilled in the art will readily recognize that the memory 618 may be implemented using a variety of techniques and devices. The memory 618, for example, may be implemented as part of the controller 606 in some circumstances.

The output device 616 provides a user interface to the monitoring user and may provide audible, visual, vibratory, or multimedia information to the monitoring user. In the exemplary embodiment, the output device 616 is a speaker and a visual display. An example of suitable visual display is liquid crystal display (LCD). As described with reference to FIG. 3 above, the monitored device 104 has a form factor similar to a wristwatch and includes band that allows the device to be worn on the wrist of the monitoring user. The visual display, therefore, is chosen to have a size that allows for easy viewing at a distance typically used to view a watch while also fitting in the wristwatch form factor.

The input device 614 provides a user interface for entering data, commands or other information. The input device 614 may be a keyboard, array of push buttons, a touch screen, microphone, camera, temperature sensor or other type of sensor. In the exemplary embodiment, the input device 614 includes an array of buttons switches that allow the monitored user or monitoring user to scroll through lists, navigate through menus and enter information.

The GPS receiver 602, therefore, determines the monitored device global position based on GPS signals received from a GPS system. The controller 606 forwards the monitored device global position coordinates as well as any other data to the transmitter 608 for wireless transmission to the monitoring device 102. Messages, data, and programming information may be received from the monitoring device 102 or other devices through the wireless receiver 604, processed by the controller 606 and forwarded to the appropriate functional blocks.

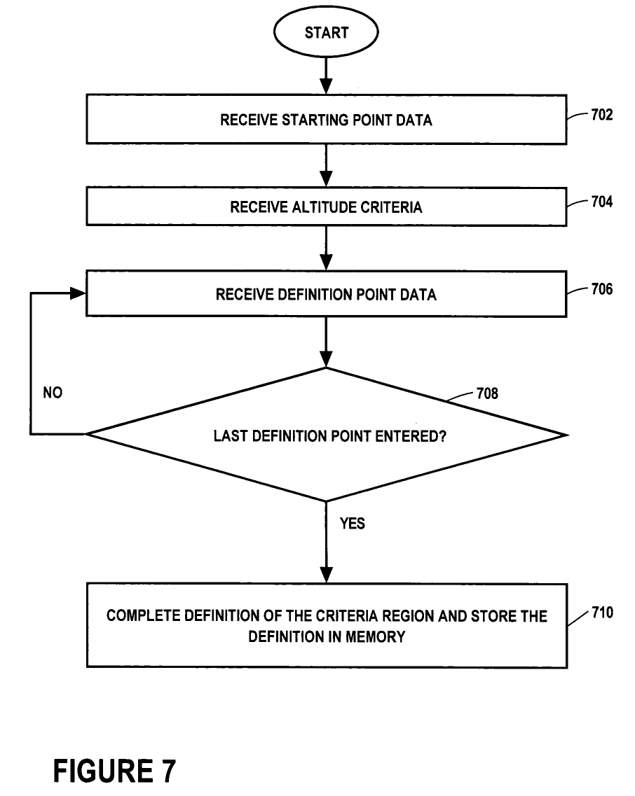

FIG. 7 is a flow chart of a method of defining the criteria region 116 in accordance with the exemplary embodiment of the invention. Various methods can be used to define the criteria region 116 and will depend on the particular monitoring system 100 and monitoring device 102. Examples of some suitable methods include downloading data from another device such as computer and using an input device 214 to graphically enter data. Criteria regions 116 may have predefined shapes that are applied to a particular location defining the criteria region 116 relative to a starting point. In the exemplary embodiment, a user manually enters information through the input device 214 on the monitoring device 102 when the monitoring device 102 is in a criteria region setup mode.

At step 702, the controller 106 receives the starting point data. In the exemplary embodiment, the user defines the first definition point 304 as the starting point of the criteria perimeter 318 by activating a switch, such as a select button, while geographically positioned at the desired starting point. In response to the switch activation, the controller 106 stores the current monitoring device global position coordinates provided by the GPS receiver 102 in memory 118.

At step 704, the controller 206 receives the altitude criteria 406. In the exemplary embodiment, the z component (altitude coordinate) of the first definition point 304 is used as the altitude reference. The user enters a maximum height above 408 the altitude reference and minimum height below 410 the altitude reference using the input device 214. If no data is entered by the user, default values are entered for the maximum and minimum heights (408,410).

At step 706, the controller 206 receives a definition point data. In the exemplary embodiment, the user defines the definition point 304-316 by activating a switch, such as a select button, while geographically positioned at the desired definition point 304-316. In response to the switch activation, the controller 206 stores the current monitoring device global position coordinates provided by the GPS receiver 202 in memory 218. Coordinates for each definition point 304-316 are associated with the order that the data for the definition points 304-316 is received.

At step 708, the controller determines if the last definition point 316 has been entered. In the exemplary embodiment, the controller determines that the last definition point 316 has been entered if a user initiated command indicates that the perimeter 318 is complete or if the last definition point 316 entered has the same GPS coordinates as the starting point 304. If the last point 316 has been entered, the method continues at step 710. Otherwise, the method returns to step 704, to receive data for another definition point (304-316).

At step 710, the controller 206 completes the definition of the criteria region 116 and stores the definition in memory 218. In the exemplary embodiment, the controller 206 defines a criteria perimeter 318 by connecting the series of definition points 304-316 with line segments 320, 322 beginning and ending with the starting point 304. The area within the criteria perimeter 318 is the criteria area 324. The altitude criteria 406 are applied to the criteria area 324 to establish the three dimensional criteria region 116. In some circumstances, the altitude criteria 406 can be eliminated, allowing the criteria region 116 to be defined as the two dimensional criteria area 324.

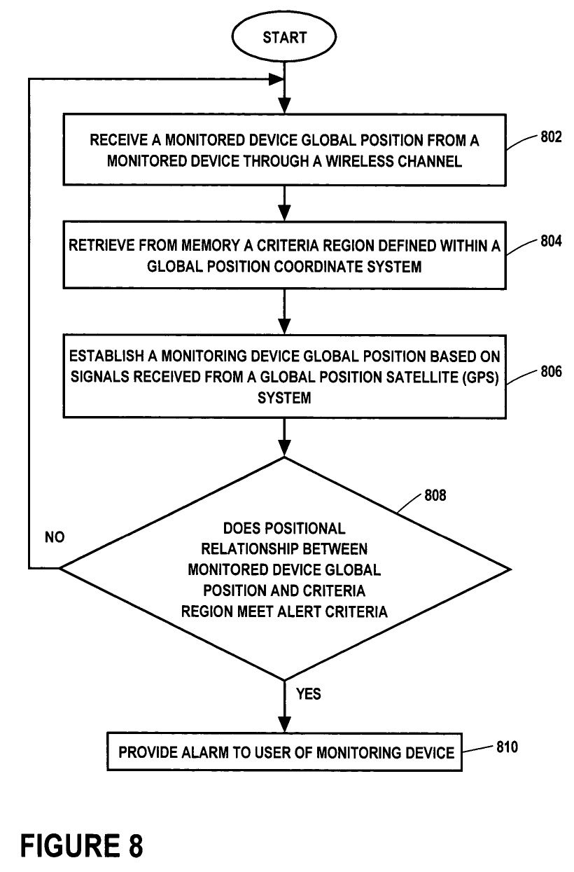

FIG. 8 is a flow chart of a method of monitoring a position of a monitored device 104 in accordance with the exemplary embodiment of the invention. Those skilled in the art will recognize that the steps described with reference to FIG. 8 may be performed by any number of devices or systems that may include software, hardware and firmware. In the exemplary embodiment, the method is performed by a monitoring device 102. Software code running on the controller 206 facilitates the exchange of signals and information among the various functional blocks of the monitoring device 102 to perform the method. The following method is described in reference to a single monitored device 104 and a single monitoring device 102. The position monitoring method, however, is performed for each monitored devices 104-108 in the exemplary embodiment. Based on these teachings, those skilled in the art will recognize the various methods of performing the steps for each of the monitored device 104-108 in accordance with known techniques. The steps may be performed in parallel for each monitored device 104-108 or the method may be performed for a single monitored device 104 before monitoring another monitored device 106, 108. Further, some of the steps may be performed in parallel, simultaneously, or nearly simultaneously, while other steps are performed in series. The order of the steps may be varied depending on the particular monitoring system 100.

At step 802, the monitoring device 102 receives the monitored device global position from the monitored device through a wireless channel 124. In the exemplary embodiment, the wireless receiver 204 receives a global position message from the monitored device 104. The wireless receiver 104 demodulates the received global message which provides at least the identity of the monitored device 104 as well as the monitored device global position. Other information such as ambient temperature, speed, heart rate, blood pressure, voice, or video information may also be included in the message depending on the particular monitoring system 100.

At step 804, the criteria region 116 defined within the global position coordinate system 404 is retrieved from memory 218. Based on the identity of the monitored device 104, the controller 206 retrieves from memory 218 the appropriate criteria region 116. In some circumstances, the same criteria region 116 may apply to each of the monitored devices 104-108.

At step 806, the monitoring device 102 establishes the monitoring device global position based signals received from the GPS system 112. The GPS receiver 202 receives the GPS signals and provides the controller 206 with the monitoring device global position.

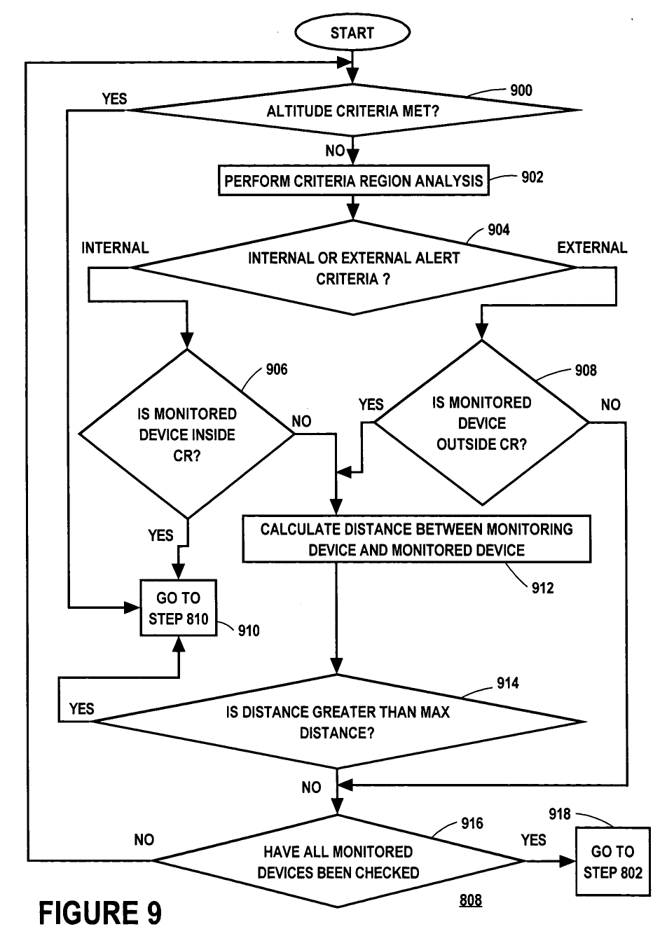

At step 808, it is determined whether the positional relationship between the monitored device global position and the criteria region 116 meet the alert criteria. As discussed below with reference to FIG. 9, the controller 206 determines if the alert criteria is met by evaluating the positional relationship between the monitored device global position and the criteria region 116 as well as the monitoring device global position in the exemplary embodiment. The alert criteria, however, may depend only on the positional relationship between the monitored device global position and the criteria region 116. If the alert criteria are not met, the method returns to step 802, where the method continues monitoring the monitored devices 104-108. If the criteria are met, the method continues at step 810.

At step 810, an alarm is provided to the user. The alarm may audible, vibratory, visual, multimedia or any combination thereof. In the exemplary embodiment, a visual icon as well as an audible alarm is provided to the user indicating that the alert criteria has been met by the global position of at least one monitored device (104-108).

FIG. 9 is a flow chart of an exemplary method of performing step 808. The process of determining if the alert criteria have been met can be performed ways other than described in FIG. 9. Accordingly, the following method is provided as a suitable example. Those skilled in the art will readily apply these teachings to recognize the various modifications and variations to the method of evaluating the global position of the monitored devices 104-108. For example, the monitoring procedures may be performed simultaneously or may be performed in different order than described in FIG. 9.

At step 900, it is determined whether the altitude of the monitored device global position meets the altitude criteria 406. In the exemplary embodiment, the controller 206 determines if the altitude criteria 406 is met for the particular monitored device global position by evaluating the z coordinate of the monitored device global position. The z coordinate is compared to the criteria height above 408 and the criteria height below 410 the reference altitude. If the altitude of the monitored device global position is above the criteria height 408 or below the criteria height 410 the alert criteria has been met and the method continues at step 910. Otherwise the method continues at step 902.

At step 902, the criteria region analysis is performed. In the exemplary embodiment, software running on the controller 206 determines if the X, Y global coordinates of the monitored device 104 are within the criteria area 324 (within the perimeter 318) defined within the GPS coordinate system using the Jordan Curve Theorem. As is known, the Jordan Curve Theorem provides a method of determining if a point is on the inside or outside of a closed polygon. One simple summarization and explanation of the theorem includes the following. Any simple closed curve C divides the points of the plane not on C into two distinct domains (with no points in common) of which C is the common boundary. If a ray is formed in a fixed direction from any point, P, in the plane of the polygon, then the ray will intersect the edges of the polygon an even number of times if P is outside the polygon and an odd number times if P is inside the polygon. Software code running on the controller 206 determines if the point defined by the GPS coordinates is inside or outside the criteria perimeter 318. Other methods, however, can be used to determine if the point is within the criteria perimeter 318. For example, if processing power is available, the point can be compared to each point inside the perimeter 318 where each point inside the perimeter 318 is defined and stored in memory 218.

At step 904, it is determined if an external criteria or an internal criteria has been defined for the monitored device 104. Based on the received identification information, the controller 206 retrieves from memory 218 the information describing the type of alert criteria. When an internal alert criterion applies to the monitored device, the alert criterion is met if the monitored device global position is within the criteria area 324. If an external criterion applies, the alert criteria are met when the monitored device global position is outside of the criteria area 324. If, at step 904, the controller 206, determines that the internal criteria applies, the method proceeds to step 906. Otherwise, the method continues at step 908.

At step 906, the controller 206 applies the results of step 902 to determine if the method should continue at step 910 or at step 912. If the monitored device global position is within the criteria area 324, the method continues at step 910. Otherwise, the method continues at step 912.

At step 908, the controller 206 applies the results of step 902 to determine if the method should continue at step 912 or at step 916. If the monitored device global position is outside the criteria area 324 (criteria region 116), the method continues at step 912. Otherwise, the method continues at step 916.

The distance between the monitoring device global position and the monitored device global position is calculated at step 912. In the exemplary embodiment, the controller 206 calculates a mathematical difference between the two coordinates to determine the distance.

At step 914, it is determined whether the distance between the monitoring device 102 and the monitored device is greater than a maximum distance threshold. In the exemplary embodiment, the controller 206 retrieves from memory 218 the maximum distance threshold corresponding to the particular monitored device 104 and compares the distance calculated in step 912. If the maximum distance has been exceeded, the method continues at step 910. Otherwise, the method continues at step 916.

At step 910, the process returns to step 810 in FIG. 8. The alert criteria have been met and an alarm is provided to the user. Depending on the particular monitoring system 100, the process of step 808 may return an indication of the type of alert criteria that has been met, allowing the user to receive alarm information providing additional information regarding the type of circumstance resulting in an alarm.

At step 916, it is determined if every monitored device global position has been analyzed. If the not, the process returns to step 900 to evaluate another monitored device global position. If all of the monitored device global positions have been evaluated, the process continues at step 918 which returns to step 802 to receive updated global positions.

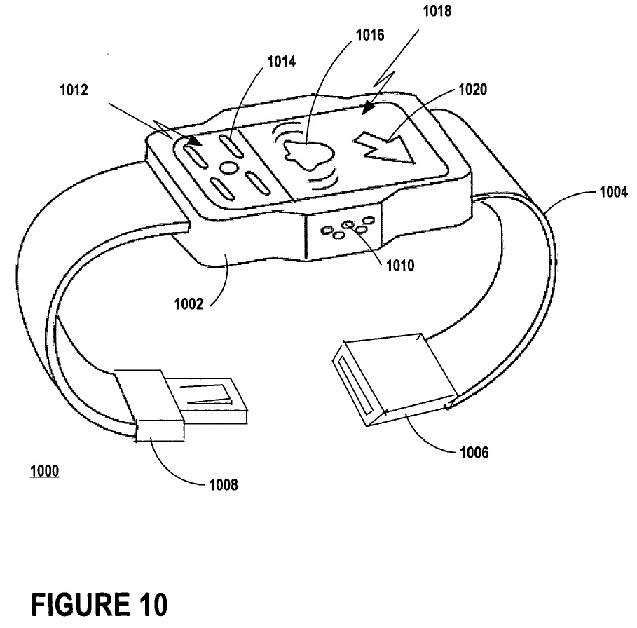

FIG. 10 is block diagram of a perspective view of a monitoring device 102 where the monitoring device 102 is implemented as a wearable wrist unit 1000. As explained above, the monitoring device 102 may be implemented in any one of numerous form factors. The wrist unit 1000 includes a housing unit 1002 that is attached to the user's wrist with a band 1004 having a buckle. In the exemplary embodiment, the buckle includes two interlocking portions 1006, 1008 that when clasped together cannot be removed without a proper key (not shown). The housing unit 1002 includes a speaker 1010, a key pad 1012 having buttons 1014 and a visual display 1018. The speaker 1010 and visual display 1018 provide an output device 216 and the keypad 1012 and buttons 1014 provide an input device 214. The visual display 1018 may display any number of visual alarms 1016, indicators 1020, text (not shown) or graphics and, in the exemplary embodiment, operates as described above with reference to FIG. 5.

Therefore, in the exemplary embodiment, a monitoring device 102 worn on the user's wrist simultaneously provides a visual display of the location of each monitored device 104-108 as well as a tracking indicator 504-508 to each monitored device global position as viewed by the user holding the wrist unit 1000 with the device orientation 524 pointing directly away from the user. In some circumstances, the visual display 1018 (216) may also display the two dimensional criteria area 324 viewed relative to the user as well as provide the relative positions of the monitored devices 104-108. The monitoring device 102 is configured by the user with minimal input where a criteria region 116 may be defined as well as other alert criteria. Default values are provided utilized by the monitoring device 102 where user inputs are not entered, are not practical or are otherwise flawed. Audio and visual alarms indicate to the user that one or more of the monitored device global positions has met an alert criterion. The user can then utilize the tracking indicator to quickly locate all of the monitored devices 104-108.

Clearly, other embodiments and modifications of this invention will occur readily to those of ordinary skill in the art in view of these teachings. An example of another useful embodiment includes a monitoring device 102 that may monitor the location of tens of monitored devices 104. The monitoring device 102 may be implemented as part of personal digital assistant (PDA) or laptop computer. Such an embodiment may be useful to teachers or chaperones where large numbers of small children are being attended to in a public area. The ability to view, on a large visual display, the relative positions of several children results in an extremely efficient system for monitoring the locations of all of the children minimizing the chance of a lost or kidnapped child.

Another embodiment may include a pet collar unit for use with a pet for training purposes or for pet containment. The monitored device 104 may be implemented in a device that can be attached to the pet's neck with a collar. Feedback is provided to the pet through audible, vibratory or unpleasant electrical signals. The system 100 may be configured such that the pet receives the feedback signal when the pet has left a defined criteria region 116. In some circumstances, the monitoring device 102 and monitored device may be implemented in a single device that is worn by the pet. During the perimeter setup mode, the user removes the pet device and enters the definition points as described above. After properly configuring the device, the user attaches the device to the pet. In such an embodiment, some of the features and functions of the monitoring device 102 may be omitted. For example, the visual display can be omitted.

Other examples will readily occur to those skilled in the art based on the teachings herein. Therefore, this invention is to be limited only by following claims, which include all such embodiments and modifications when viewed in conjunction with the above specification and accompanying drawings.

What is claimed is:

1. A position monitoring device configured to determine if a global position of a monitored device is within a criteria region defined within a global position coordinate system.

2. A position monitoring device in accordance with claim 1, wherein the criteria region is a three dimensional region defined in a three dimensional coordinate system.

3. A position monitoring device in accordance with claim 2, wherein the criteria region comprises:
a two dimensional criteria area defined in a plane; and
a criteria height defined in an axis perpendicular to the plane.

4. A position monitoring device in accordance with claim 3, wherein the criteria height comprises:
a maximum height above the plane; and
a minimum height below the plane.

5. A position monitoring device in accordance with claim 1, wherein the criteria region is a two dimensional area.

6. A position monitoring device in accordance with claim 5, wherein the two dimensional area is a polygon having a plurality of sides formed by a series of line segments.

7. A position monitoring device in accordance with claim 5, wherein the two dimensional area is a circle.

8. A position monitoring device in accordance with claim 1, wherein the criteria region is stationary relative to the coordinate system.

9. A position monitoring device in accordance with claim 1, wherein the criteria region is defined relative to a dynamic reference position.

10. A position monitoring device in accordance with claim 9, wherein the dynamic reference position is a monitoring device global position of the monitoring device.

11. A position monitoring device in accordance with claim 10, comprising:
a global position satellite (GPS) receiver for providing the monitoring device global position.

12. A position monitoring device in accordance with claim 1, comprising:
a receiver for receiving the monitored device global position through a wireless channel.

13. A position monitoring device in accordance with claim 12, comprising an output device for conveying, to a user, the monitored device global position relative to the criteria region.

14. A position monitoring device in accordance with claim 13, wherein the output device is an audio device providing an audio alarm signal when an alert condition based on a relationship between the criteria region and the monitored device global position is met.

15. A position monitoring device in accordance with claim 13, wherein the output device is a visual display graphically displaying the relative position between the monitored device global position and the criteria region.

16. A position monitoring device in accordance with claim 13, wherein the output device is a vibratory device providing vibratory alarm signal when an alert condition based on a relationship between the criteria region and the monitored device global position is met.

17. A position monitoring device in accordance with claim 13, wherein the output device is a radio frequency transmitter for transmitting a radio frequency alarm signal to the monitored device.

18. A position monitoring device in accordance with claim 13, wherein the output device is a sonic transmitter for transmitting a sonic alarm signal to the monitored device.

19. A position monitoring device comprising:
a wireless receiver for receiving, through a wireless channel, a monitored device global position from a monitored device;
a memory for storing a criteria region defined within a global position coordinate system; and
a controller for determining if the monitoring device global position is within the criteria region.

20. A position monitoring device in accordance with claim 19, further comprising an output device for conveying, to a user, the monitored device global position relative to the criteria region.

21. A position monitoring device in accordance with claim 19, further comprising an output device responsive to the controller and providing an alarm when an alert condition based on a relationship between the criteria region and the monitored device global position is met.

22. A position monitoring device in accordance with claim 20, wherein the output device is an audio device providing an audio alarm signal when an alert condition based on a relationship between the criteria region and the monitored device global position is met.

23. A position monitoring device in accordance with claim 13, wherein the output device is a vibratory device providing a vibratory alarm signal when an alert condition based on a relationship between the criteria region and the monitored device global position is met.

24. A position monitoring device in accordance with claim 20, wherein the output device is a visual display graphically displaying the relative position between the monitored device global position and the criteria region.

25. A position monitoring device in accordance with claim 20, wherein the output device is a vibratory device providing vibratory alarm signal when an alert condition based on a relationship between the criteria region and the monitored device global position is met.

26. A position monitoring device in accordance with claim 19, wherein the output device simultaneously conveys, to the user, a plurality of relationships between a plurality of monitored devices and at least one criteria region.

27. A position monitoring device in accordance with claim 21, wherein the alert condition is met when the monitored device is within the criteria region.

28. A position monitoring device in accordance with claim 21, wherein the alert condition is met when the monitored device is outside of the criteria region.

29. A position monitoring device in accordance with claim 21, wherein the alert condition is met when a distance between the monitored device and the monitoring device is greater than a maximum distance threshold.

30. A position monitoring device in accordance with claim 29, further comprising an input device for receiving data input from a user, the data input at least partially defining the criteria region.

31. A position monitoring device in accordance with claim 30, wherein the input device is for providing, to the controller, a series of definition points located on a perimeter of the criteria region.

32. A position monitoring device in accordance with claim 31, wherein the input data is an indication of a monitored device global position when the monitored device is located at a definition point.

33. A position monitoring device in accordance with claim 32, wherein the input device is a push button switch providing each definition point in response an activation of the switch when the monitoring device is positioned at a definition point.

34. A position monitoring device comprising:
a wireless receiver for receiving, through a wireless channel, a monitored device global position from a monitored device;
a global positioning satellite (GPS) receiver for providing a monitoring device global position of the monitoring device;
an input device responsive to a user to provide a series of definition points;
a memory for storing the criteria region having a perimeter comprising a series of line segments connecting the definition points within a global position coordinate system;
a controller for determining if the monitoring device global position is within the criteria region; and
an output device for conveying to the user a relationship between the criteria region and the monitored device global position.

35. A position monitoring device in accordance with claim 34, wherein the criteria region is a three dimensional region defined in a three dimensional coordinate system.

36. A position monitoring system comprising:
a monitored device for wirelessly transmitting a monitored device global position based on global positioning satellite (GPS) signals; and
a monitoring device for determining based on the monitored device global position received from the monitored device, if the monitored device is within a criteria region.

37. A method for monitoring a position of a monitored device, the method comprising:
determining if a relationship between a monitored device global position of a monitored device and a criteria region defined within a global position coordinate system is defined by an alert criteria.

38. A method performed by a monitoring device for monitoring a position of at least one monitored device, the method comprising:
receiving a monitored device global position from a monitored device through a wireless channel;
establishing a monitoring device global position based on signals received from a global position satellite (GPS) system;
retrieving from memory a criteria region defined within a global position coordinate system;
determining if a positional relationship between the monitored device global position and the criteria region meets an alert criteria;
providing an alarm to a user of the monitoring device if the relationship meets the alert criteria.

39. A method in accordance with claim 38, wherein the providing the alarm comprises providing an audible alarm.

40. A method in accordance with claim 38, wherein the providing the alarm comprises providing a visual alarm.

41. A method in accordance with claim 38, wherein the providing the alarm comprises providing a vibratory alarm.

42. A method in accordance with claim 38, wherein determining if the positional relationship between the monitored device global position and the criteria region meets an alert criteria comprises:
determining if the monitored device global position is located inside the criteria region.

43. A method in accordance with claim 38, wherein determining if the positional relationship between the monitored device global position and the criteria region meets an alert criteria comprises:
determining if the monitored device global position is located outside the criteria region and a distance between the monitored device global position and the monitoring device global position is greater than a maximum distance threshold.

44. A method performed by a monitoring device for monitoring a position of at least one monitored device, the method comprising:
receiving a monitored device global position from a monitored device through a wireless channel;
establishing a monitoring device global position based on signals received from a global position satellite (GPS) system;
retrieving from memory a criteria region defined within a global position coordinate system;
determining if the monitored device global position is within the criteria region;
determining if a distance between the monitoring device global position and the monitored device global position is greater than a maximum distance threshold;
providing an alarm to a user of the monitoring device if: the distance is greater that the maximum and the monitored device is outside the criteria region.

45. A monitoring device comprising:
a global positioning satellite (GPS) receiver providing a monitoring device global position;
a compass for providing a global reference direction;
a controller for determining, based on an orientation of the monitoring device to the global reference direction, a plurality of tracking indicators indicating a plurality of tracking directions from the monitoring device global position to each of a plurality of monitored device global positions; and
a visual display for simultaneously providing the plurality of tracking indicators to the user as a plurality of visual indicators indicating the tracking directions.

46. A monitoring device in accordance with claim 45, further comprising a wireless receiver for receiving the plurality of monitored device global positions from a plurality of monitored devices.

47. A monitoring device in accordance with claim 46, wherein the controller is for establishing the tracking indicators by:
determining the tracking directions based on a plurality of relative positions between the monitoring device global position and the monitored device global positions;
calculating an offset angle between the global reference direction and an orientation direction of the monitoring device; and
applying the offset angle to each tracking direction to provide each tracking indicator.

48. A monitoring device in accordance with claim 47, further comprising an audio output device for providing an audible alarm when any one of a plurality of distances between each monitored device global position and the monitoring device global position is greater than a maximum distance threshold.

49. A portable monitoring device for tracking a plurality of portable monitored devices, the monitoring device comprising:
a global positioning satellite (GPS) receiver providing a monitoring device global position;
a compass for providing a global reference direction;
a controller for providing a plurality of tracking direction indicators indicating a plurality of tracking directions from the monitoring device global position to the plurality of monitored device global positions by determining each tracking direction based on a relative position between the monitoring device global position and each monitored device global position, determining an offset angle between a monitoring device orientation direction and the global reference direction and applying the offset angle to each tracking direction to provide each tracking indicator; and
a visual display for simultaneously displaying a plurality of visual tracking indicators based on the tracking direction indicators, the visual tracking indicators indicating the tracking directions.

50. A portable monitoring device in accordance with claim 49, wherein the compass is a magnetic compass providing a global reference direction relative to a magnetic polarity of Earth.

51. A portable monitoring device in accordance with claim 49, wherein the global reference direction is referenced to polar north.

52. A portable monitoring device in accordance with claim 51, wherein the global reference is polar north.

53. A portable monitoring device in accordance with claim 52, wherein the global reference direction is calibrated to magnetic north in accordance with a geographical location of the monitoring device.

54. A method in accordance with claim 53, wherein the calibrating comprises:
accepting input data from a user indicating the geographical region; and
retrieving from memory a calibration factor associated with the geographical region.

55. A method for monitoring a global position of a plurality of monitored devices relative to a monitoring device global position, the method comprising:
calculating a monitoring device global position of a monitoring device;
receiving a plurality monitored device global positions through a wireless channel;
retrieving from a compass, a global reference direction;
determining, based on an orientation of the monitoring device to the global reference direction, a plurality of tracking indicators indicating a plurality of tracking directions from the monitoring device global position to each of a plurality of monitored device global positions; and
simultaneously displaying the plurality of tracking indicators to a user as a plurality of visual indicators indicating the tracking directions.

56. A method in accordance with claim 55, wherein the determining comprises:
determining the tracking directions based on a plurality of relative positions between the monitoring device global position and the monitored device global positions;
calculating an offset angle between the global reference direction and an orientation direction of the monitoring device; and
applying the offset angle to each tracking direction to provide each tracking indicator.

57. A method in accordance with claim 56, further comprising:
providing an audible alarm when any one of a plurality of distances between each monitored device global position and the monitoring device global position is greater than a maximum distance threshold.

58. A method for tracking a plurality of portable monitored devices, the method comprising:
retrieving a monitoring device global position from a global positioning satellite (GPS) receiver;
accepting, from a compass, a signal indicating a global reference direction;
providing a plurality of tracking direction indicators indicating a plurality of tracking directions from the monitoring device global position to the plurality of monitored device global positions by determining each tracking direction based on a relative position between the monitoring device global position and each monitored device global position;
determining an offset angle between a monitoring device orientation direction and the global reference direction;
applying the offset angle to each tracking direction to provide each tracking indicator; and
simultaneously displaying a plurality of visual tracking indicators based on the tracking direction indicators, the visual tracking indicators indicating the tracking directions.

59. A method in accordance with claim 58, wherein the compass is a magnetic compass providing a global reference direction relative to a magnetic polarity of Earth.

60. A method in accordance with claim 58, wherein the global reference direction is referenced to polar north.

61. A method in accordance with claim 60, wherein the global reference is polar north.

62. A method in accordance with claim 58, further comprising:
calibrating the global reference direction to magnetic north in accordance with a geographical location of the monitoring device.

63. A method in accordance with claim 62, wherein the calibrating comprises:
accepting input data from a user indicating the geographical region; and
retrieving from memory a calibration factor associated with the geographical region.
